(19) United States
(12) Patent Application Publication
(10) Pub. No.: US 2012/0118875 A1
(43) Pub. Date: May 17, 2012

(54) Oven

(75) Inventor: Rudolf Jussel, Feldkirch-Gisingen (AT)

(73) Assignee: IVOCLAR VIVADENT AG, Schaan (LI)

(21) Appl. No.: 13/282,869

(22) Filed: Oct. 27, 2011

(30) Foreign Application Priority Data
Nov. 15, 2010 (EP) 10 191 244.2

(51) Int. Cl. H05B 6/10

(52) U.S. Cl. 219/634

(57) ABSTRACT

An oven, in particular a dental oven, with a heating chamber (12), into which dental restoration parts that are to be thermally treated, in particular multi-unit dental restoration parts, can be introduced. The dental oven includes a thermal heating component (16) which heats the dental restoration parts (30) via thermal conduction, thermal convection and/or infrared radiation, so that the dental restoration parts (30) are received in or on a susceptor comprised of a highly heat-conductive material, in particular silicon carbide.

### CROSS-REFERENCE TO RELATED APPLICATIONS

This application claims the benefit of European Patent Application No. 10 191 244.2 filed Nov. 15, 2010, which is hereby incorporated by reference in its entirety.

### TECHNICAL FIELD

The invention concerns an oven, in particular a dental burning oven, and a method for sintering a dental restoration part.

### BACKGROUND OF THE INVENTION

Dental ovens are typically comprised of a resistance heating in which the firing chamber is heated to a high temperature via heating coils which are substantially evenly distributed around a firing chamber.

The heat radiation given off by the heating elements is transferred to the dental restoration parts which are located in the firing chamber, primarily through heat radiation, heat conduction but also through convection.

It is critical for the quality of the finished dental restoration part that the heat treatment is carried out using high-quality burning ovens and a very homogeneous and exactly pre-determined temperature regime. In order to provide multi-unit dental restoration parts by sintering, for example, ZrO₂, a sintering cycle period of three hours for three-unit crowns or eight hours for six-unit crowns is required.

The reduction of the sintering period of long-span, i.e., multi-unit dental restoration parts, bears a considerable risk of permanent distortion or reduced quality because of microstructural inhomogenities which are developing and as a consequence thereof a reduction of material properties such as strength. This is caused in particular by temperature inhomogenities which are predefined by the geometric design of the firing chamber and which increase in particular due to rapid heating cycles.

Various attempts have been made in order to reduce the cycle time considerably as it is important for the throughput in the workflow of dental laboratories. With the help of special temperature profiles and an adapted design of the working area of the dental burning oven as well as exactly given arrangement rules of the dental restoration parts in the firing chamber the cycle time for processing multi-unit dental restoration parts was reduced from eight hours to three hours, however, special ovens have to be used which can lead to relatively high costs of, for example, EUR 10,000.00, for the dental laboratory in question.

Moreover, further numerous suggestions have been made to improve the heating and cooling curves of dental restoration parts, in most cases, however, of single-unit dental restoration parts, using so-called kiln furniture. DE 10 2008 015 483 discloses the use of a bed of balls as kiln furniture by which temperature sensing can be improved.

Under certain circumstances, kiln furniture allows for a certain improvement in the balancing of the temperature in the firing chamber which is good for the quality of the dental restoration parts, especially when it comes to multi-unit bridges. However, they comprise a considerable heat capacity which means that heating and cooling takes longer, and this is something which is contrary to the need for a reduction of the cycle time.

Especially when trying to shorten process time, depending on the type of kiln furniture used, the temperature gradients can even be increased especially when this type of kiln furniture has a temperature-insulating effect.

In order to achieve a short cycle time at least for small, for instance single-unit dental restoration parts, it has also been suggested to build burning ovens of various sizes so that a dental laboratory is provided with a burning oven with an extremely small and compact firing chamber and a further oven with a large-scale firing chamber.

This solution allows for a significantly reduced cycle time for small, i.e., single- or double-unit dental restoration parts with good-quality results. However, this solution is very expensive which is why it is not widely accepted in practice.

### SUMMARY OF THE INVENTION

It is therefore an object of the invention to create a burning oven and a method, which are considerably improved with regard to the firing result, especially with regard to the cycle time, in spite of a minimal additional effort.

Surprisingly, by adding the susceptor according to the present invention a considerable reduction of the time period of the firing cycle is achieved, e.g., from five hours to ninety minutes for six-unit dental restoration parts. This is especially surprising because a susceptor made up of a highly heat-conductive material, in particular, of silicon carbide, is received in the firing chamber in addition. The effect is that the cycle time is reduced by balancing the interior temperature in the highly heat-conductive container which takes up the heat very well and gives it off to the dental restoration part, thus can insofar be considered a susceptor.

Surprisingly enough, the heat is distributed considerably better and more quickly in the dental restoration part due to the large heat-absorbing surfaces of the highly heat-conductive container compared to the dental restoration part. By making the dental restoration part touch the container or at least close proximity of the dental restoration part in or at or on the container, the heat transfer can be ensured on a large scale, and in the interior of the container a very even temperature distribution takes place which is more even by one order of magnitude than the temperature distribution in the firing chamber of a commercially available dental burning oven.

It is particularly favorable according to the present invention that the short cycle time can also be realized with dental restoration parts with a very poor intrinsic thermal conductivity which are to be thermally treated, as is the case for instance with ZrO₂ with only about 2 W/mK.

Altogether, one is not so dependent anymore on the possibly poor intrinsic thermal conductivity of the ceramic which is to be thermally treated as now due to the fast heat transfer in the container the temperature is fed virtually at several places at the same time and very evenly distributed. In addition, at higher temperatures at which the actual sintering process starts, heat radiation occurs as a dominant effect. When using a material for the susceptor container such as SiC with a high emissivity, not only is the heat absorption of a hotter temperature source better but also the heat emission to a colder place, namely according to the present invention, to the dental restoration parts or colder surfaces in the interior of the susceptor which in addition balance the temperatures very quickly due to their high intrinsic heat conduction.

It is particularly favorable according to the present invention when the susceptor container comprises a wall thickness of about 2 mm and consists of a material with a heat conductivity of more than about 100 W/mK. In spite of the thin walls, the heat can then be distributed well in the container and thin walls also cause a low additional mass to be heated. It is a matter of course that the relation of additional heat capacity of the desired balancing in temperature can be adapted on a large scale to the requirements through a suitable choice of material and wall thickness. Thus, for instance, the bottom wall of the container can be thicker than the side wall, for instance about 2.5 mm to about 1.5 mm in order to achieve a good heat distribution at least in a two-dimensional way.

The adaptation can also be necessary due to constructional deliberations as the preferred material for the container has to be constructed in a ceramic-appropriate way.

The dental restoration part in particular lies flat in the container and extends substantially through the interior of the container, for instance over about 80 mm. The container also occupies a large part of the space of the firing chamber, with the container being preferably accommodated centrally so that there is a uniformly spaced-apart relationship from all sides with the wall of the firing chamber and in particular with the heating elements.

Preferably, the burning oven is operated in such a way that first the dental restoration part is inserted into the container. It is put down carefully so that it is in good contact with the bottom wall of the container. Then the cover of the container is closed and the container is inserted into the dental burning oven or into its firing chamber in an exactly central manner. For this, the dental oven can be provided with corresponding guideways or recesses in order to ensure an accurate positioning and mounting of the container. After closing the hood or door of the burning oven the highest possible heating rate of the material is chosen in sections in coordination with the optimum sintering rate of the material, for instance up to 400° C./min, in order to be able to carry out the heat treatment at a maximum speed.

It is a matter of course that it is also possible in any suitable other way to achieve a pre-heating of the dental restoration parts at, for instance, about 700° C. with the help of pre-heating ovens known per se. In this case, the dental restoration part preferably together with the container is transferred from the pre-heating oven to the firing chamber wherein it is checked as a precautionary measure that no undesired shifting of position of the dental restoration parts in the container has happened due to the transport.

According to the present invention it is especially favorable when the container has a flat-cylindrical shape and a height of for instance about one fifth of its diameter. In this way, an especially good heat transfer takes place, especially from the cover of the container to the dental restoration part.

Furthermore, it is especially favorable according to the present invention that the material of the container comprises a very poor heat resistance or alternatively, a very good heat conductivity. A heat conductivity of at least about 100 W/mK is preferred, a heat conductivity of about 200 W/mK is preferred even more. Containers of this type can be made of special ceramics such as silicon carbide wherein containers made of molybdenum can also be used which also comprise a very high heat conductivity of about 139 W/mK. In case of oxidizing atmospheres, the molybdenum can also have a coating. When limiting the service temperature to a maximum of about 1500° C. the use of aluminium nitride (AlN) with a heat conductivity of about 180 W/mK is also possible.

According to the present invention it is also especially favorable that similar containers are used in the food industry as susceptors and in this way can easily be obtained relatively cheaply.

A further especially favorable advantage of the invention is that an ordinary burning oven can be provided practically with the containers according to the invention and in this way it is possible according to the invention to provide the dental ovens which are already available with the containers and thus no additional procurement efforts are required. The dental oven must only be intended for fast heating rates without losses when it comes to its durability and function.

According to the invention it is also especially favorable that the container according to the invention is also especially suitable for preparing and transferring the material to be burned. For this purpose the dental restoration parts to be burned only need to be arranged and carefully adjusted in the container so that they are in best possible contact with each other. This container is then received by a pre-heating oven and pre-heated in this oven for instance over a period of one hour to a temperature of about 700° C. During pre-heating, in a further container a burning cycle of other dental restoration parts can be run in the actual dental oven and after completion of this burning cycle the containers are changed without further ado, or the container containing the finished dental restoration parts is removed from the burning oven and instead the container with the pre-heated dental restoration parts is inserted.

The insertion is carried out in a central manner but it is also possible to provide the bottom of the firing chamber with appropriate marks or even stops which simplify the central insertion of the container.

As a matter of course constructional elements for a safe handling and a safe transportation by the human hand, in case the container is cold, as well as for a safe handling with tongs or a lifter or similar device can be installed or embedded in the container.

Within the container further marks, in the way of coordinates, can be inserted which are helpful for the assignment of the dental parts to specific orders.

In an advantageous development the container is provided with recesses or pores whose size is preferably lower than half the size of a tooth. In this way the heat capacity of the container can further be reduced while the effect of the temperature balancing is maintained essentially.

In a further advantageous development of the burning oven according to the invention several containers are jointly burnt while being stacked or at least placed on top of each other. For instance, two containers made of silicon carbide can easily be supported by each other via three silicon carbide supports each and can receive the dental restoration parts in any suitable way. The temperature balancing according to the invention is not affected by this but as a matter of course it has to be ensured that the stack of containers is not shaken nor even damaged when closing the hood of the oven.

In this connection the uniform spacing to the wall of the firing chamber according to the invention is especially favorable: it prevents a collision between the hood and the container, especially when the hood of the oven is swiveled to the top and not lifted to the top.

According to the present invention it is especially favorable that the container is comprised of a highly heat-conductive material and formed as a closed container. In this way, impurities from the dental oven cannot have an influence on the dental restoration parts. In the case of dental restoration parts made of ZrO₂ these can for instance be impurities from sintering furnaces with MoSi heating elements which are lacking a protective layer due to the operating time or type. Without the invention these lacking protective layers can lead to temporary yellow-green discolorations of the dental restoration parts.

Due to its own high thermal conductivity the susceptor container itself is, allowing for a favorable design, very resistant against temperature shock loads and very break-proof. SiC is in addition very hard as a result of which the container becomes very robust and durable. As a consequence the container is easy to clean. For instance, impurities like that in dental manufacturing processes like, for instance, in the processing of lithium disilicate ceramics, and additives required for this, can remain and can, if necessary, be removed quickly and easily from time to time e.g. by means of sandblasting.

As a consequence, the container of the present invention can of course be used over a very long period of time. With the help of the possibility of easy cleaning the same container can also be used in a variable way for different processes, namely, for instance, for the sintering of ZrO₂ and the heat treatment of lithium disilicate ceramics.

According to a further, especially favorable aspect of the invention the container takes up the bottom space of the firing chamber and is closed via a cover. Alternatively, it can also be closed via a hood. In both cases, the heating of the highly heat-conductive container and in this way indirectly of the dental restoration parts located in the container takes place through a combination of heat radiation, heat conduction and convection. Due to the air which rises along the heating elements or due to the air inlets and outlets which are installed in an oven, convection air rollers occur in the firing chamber which may increase temperature inhomogenities in a firing chamber.

As a consequence, this can lead to varying and unsatisfactory results of restoration.

By shielding the dental restoration parts from such unsatisfactory convection air rollers with the help of the susceptor container, this can be prevented securely and the heating of the dental restoration parts takes place indirectly via the container which remains on an equal temperature level. As the temperature level is the same throughout the container no convection occurs within the container and the convection which occurs on the outside does not affect the balancing of temperature, in view of the high thermal conductivity of the container.

In a favorable development the dental restoration part is supported via a support structure. Such a support structure can, for instance, be realized via support struts which extend transversely between the molars of a, for instance, ten-unit bridge and can also act as an additional supporting structure in incisal direction, or it can be realized via a disc-shaped support structure which can also receive several multi-unit dental restoration parts which are each supported laterally by supporting ribs.

The disc-shaped support structure can remain in the container in this embodiment and it is possible to remove the dental restoration parts only after the heat treatment by severing the supporting ribs. This makes it possible to store the dental restoration parts during the heat treatment in an optimum way and to facilitate distortion-free sintering.

As the container takes up the convection heat and converts it into radiant heat it is justifiable to consider it a susceptor.

It is especially favorable that the dental restoration parts are received in or on a susceptor container comprised of a highly heat-conductive material which in particular has a thermal conductivity of more than about 100 W/mK, preferably approximately 200 W/mK.

It is especially favorable that the susceptor container comprises a wall thickness of about 1 to about 5 mm, in particular about 1.5 to about 2.5 mm and preferably approximately 2 mm.

It is especially favorable that the susceptor is comprised of a sintered ceramic material that is temperature-resistant up to at least about 1650° C., preferably up to about 1900° C., and in particular is comprised of silicon carbide and has a thermal conductivity of about 120 Watt/mK.

It is especially favorable that the dental restoration part is formed of multiple units and comprises 4, 6 or up to 14 units, with 14 units forming a complete dental arch.

It is especially favorable that a support structure of the dental restoration parts at least supports two areas of the dental restoration parts, in particular with the aid of supporting ribs, with in particular at least two dental restoration parts being received within a support disk and being connected therewith via supporting ribs.

It is especially favorable that the emission coefficient of the susceptor is larger than about 0.8, in particular approximately 0.9.

It is especially favorable that the susceptor is formed as a container having a bottom wall, on which the dental restoration parts rest upon, and side walls surrounding the dental restoration parts, and/or the susceptor surrounds the dental restoration parts in a pot- or cup-shaped manner and in particular comprises a cover.

It is especially favorable that the susceptor supports the dental restoration parts and that the dental restoration parts in particular lie flat and in a uniformly distributed manner on the susceptor and/or that the dental restoration parts rest on the susceptor at several points.

It is especially favorable that the burning oven at least at some sections thereof comprises a heat gradient of more than about 80 K/min, in particular of approximately 400 K/min, and that both the heating as well as the burning or sintering and also the cooling of the dental restoration parts is carried out in or on the susceptor.

It is especially favorable that the susceptor is formed as a closed container that is centrally accommodated within the combustion or firing chamber, in particular in a uniformly spaced-apart relationship with the walls of the firing chamber and/or the heating elements, with the susceptor in particular covering more than half of the bottom or base of the firing chamber, and that there is a gap or distance between the susceptor and the heating elements of always more than about 1 cm.

It is especially favorable that the container that forms the susceptor, comprises a height that is slightly more than the maximum height of a dental restoration part and that the largest dental restoration part that is to be burned, substantially completely and randomly oriented extends through the interior of the susceptor.

It is especially favorable that the container is formed as a closed container and divides the firing chamber into the susceptor interior and the susceptor exterior, with the one or more dental restoration parts that is/are to be burned, being completely accommodated within the interior of the susceptor.

It is especially favorable that the container as a closed susceptor container is intended for being introduced into a conventional dental burning oven and is comprised of a highly thermally conductive material such as silicon carbide and comprises a wall thickness of less than about 5 mm, preferably approximately 2 mm.

It is especially favorable that the dental restoration part that has an extension of about 80 mm or more, is inserted into a susceptor, in particular comprised of silicon carbide, within the firing chamber, and that the thermal treatment of the dental restoration part in the dental oven takes place in a time less than about 100 minutes.

It is especially favorable that the dental restoration part or the dental restoration parts is/are inserted into the susceptor at a room temperature of less than about 50° C. or at the temperature of a preheating oven, and that the susceptor remains closed during the heat treatment cycle.

### BRIEF DESCRIPTION OF THE DRAWINGS

Embodiments of the present invention will be more fully understood and appreciated by the following Detailed Description in conjunction with the accompanying drawing, in which:

FIG. 1 shows a schematic view of a dental burning oven according to the invention.

### DETAILED DESCRIPTION

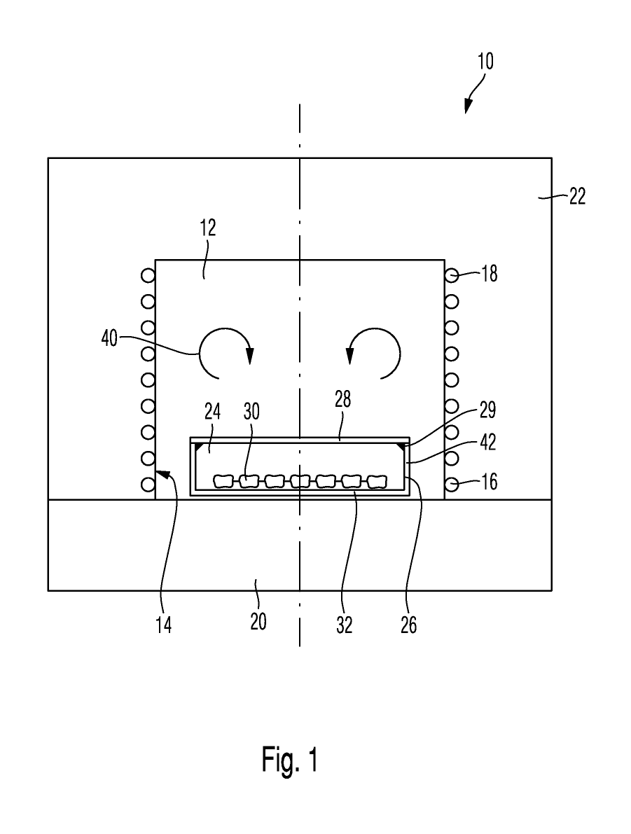

The dental burning oven 10 as shown in FIG. 1 comprises a cylindrically-shaped firing chamber 12 which comprises a heating component 16 at the wall 14 of the firing chamber. The heating component can either consist of a circumferential heating coil 18, as shown in FIG. 1, or of vertically arranged heating rods. In a way known, the burning oven 10 consists of an oven base 20 and a burning oven hood 22 wherein the hood 22 can be swiveled away to the top in order to uncover the material to be burned.

In the present invention a dental restoration part or a multiple array of dental restoration parts is received in the firing chamber 12. In the present invention in a unique way the insertion does not occur directly but indirectly via a container 24, which is made up of susceptor material, for instance of silicon carbide, and which is highly heat-conductive. Preferably, the thermal conductivity of the container material is about 100 to about 180 W/mK, i.e. about 140 W/mK.

The container 24 is formed as a flat cylinder and is provided with a cup-shaped container 26 and a container cover 28 in the present invention. The container cover 28 is mounted on the container cup 26 in a way known per se via positive locking elements 29 so that all in all the container 24 is formed as a closed container.

The container 24 receives dental restoration parts 30 wherein the embodiment shows a schematic view of a seven-unit crown. The dental restoration part does not fill up the container 24, however, it extends transversely through the container so that its transverse extension is not much lower than the inner diameter of the container 24.

It is a matter of course that several smaller dental restoration parts 30 can be arranged next to each other or that smaller containers 24 can be used and where necessary several containers can be used which are arranged either next to each other or on top of each other.

Even if the container 24 rests directly upon the oven base 20 in the present embodiment, in a modified embodiment the container is provided with feet or rests upon small blocks so that the bottom 32 of the container is spaced apart from the base of the oven 20. In this embodiment the heat transfer from the heating 16 to the container 24 is improved.

As shown in FIG. 1 by heating up the heating component 16 a ring-shaped convection roller 40 occurs which impinges especially the cover but in part also the side walls 42 of the container. This and the direct heat radiation of the heating component 16 heats the container 24 rapidly, especially when a large heating temperature gradient is used as intended according to the invention. However, this does not lead to the introduction of temperature peaks because temperature peaks induced from the outside are reduced by heating the dental restoration parts 30 in the container 24 indirectly and temperature peaks are not present anymore in the container 24.

It is favorable according to the invention when the walls of the container are not thicker than for instance 5 mm. The bottom 32 of the container can, for instance, have a wall thickness of 2.5 mm, the wall 42 of the container can have a wall thickness of 1.5 mm and the cover can have a wall thickness of 2 mm. Such a container can be handled in a sufficiently safe way and is provided with such a low thermal capacity that the disadvantages caused by this are overcompensated for by the temperature balancing together with the high heating and cooling temperature gradient.

The burning oven 10 according to the present invention required a cycle time of 90 minutes for a six-unit crown while the same oven without a container required a cycle time of 5 hours.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. An oven comprising:
a firing chamber, into which dental restoration parts that are to be thermally treated, can be introduced;
a thermal heating component that heats the dental restoration parts by thermal conduction, convection or infrared radiation, or a combination thereof;
wherein the dental restoration parts are received in or on a susceptor container comprised of a highly heat-conductive material which has a thermal conductivity of more than about 100 W/mK.

2. The oven as claimed in claim 1, being a dental oven.

3. The oven as claimed in claim 1, wherein the highly heat-conductive material has a thermal conductivity of approximately 200 W/mK.

4. The oven as claimed in claim 1, wherein the dental restoration parts comprise multi-unit dental restoration parts.

5. The oven as claimed in claim 1, wherein the susceptor container comprises a wall thickness of about 1 to about 5 mm.

6. The oven as claimed in claim 4, wherein the susceptor container comprises a wall thickness of about 1.5 to about 2.4 mm.

7. The oven as claimed in claim 5, wherein the susceptor container comprises a wall thickness of approximately 2 mm.

8. The oven as claimed in claim 1, wherein the susceptor is fabricated of a sintered ceramic material that is temperature-resistant up to at least about 1650° C.

9. The oven as claimed in claim 1, wherein the susceptor is fabricated of a sintered ceramic material that is temperature-resistant up to at least about 1900° C.

10. The oven as claimed in claim 1, wherein the susceptor is fabricated of silicon carbide and has a thermal conductivity of 120 Watt/mK.

11. The oven as claimed in claim 1, wherein the dental restoration part is formed of multiple units and comprises 4 to 14 units, with 14 units forming a complete dental arch.

12. The oven as claimed in claim 1, wherein a support structure of the dental restoration parts at least supports two areas of the dental restoration parts with the aid of supporting ribs, wherein at least two dental restoration parts are received within a support disk and are connected therewith via supporting ribs.

13. The oven as claimed in claim 1, wherein the susceptor has an emission coefficient larger than about 0.8.

14. The oven as claimed in claim 13, wherein the emission coefficient is approximately 0.9.

15. The oven as claimed in claim 1, wherein the susceptor is formed as a container having a bottom wall, on which the dental restoration parts rest upon, and side walls surrounding the dental restoration parts, and/or the susceptor surrounds the dental restoration parts in a pot- or cup-shaped manner and comprises a cover.

16. The oven as claimed in claim 1, wherein the susceptor supports the dental restoration parts and wherein the dental restoration parts lie flat and in a uniformly distributed manner on the susceptor and/or that the dental restoration parts rest on the susceptor at several points.

17. The oven as claimed in claim 1, wherein the oven at least at some sections thereof comprises a heat gradient of more than about 80 K/min, and that both the heating as well as the burning or sintering, and also the cooling of the dental restoration parts is carried out in or on the susceptor.

18. The oven as claimed in claim 17, wherein the heat gradient is approximately 400 K/min.

19. The oven as claimed in claim 1, wherein the susceptor is formed as a closed container that is centrally accommodated within the firing chamber, in a uniformly spaced-apart relationship with the walls of the firing chamber and/or the heating elements, wherein the susceptor covers more than half of the bottom or base of the firing chamber, and wherein a gap or distance between the susceptor and the heating elements is greater than 1 cm.

20. The oven as claimed in claim 1, wherein the susceptor comprises a height that is slightly more than a maximum height of a dental restoration part and that a largest dental restoration part that is to be burned, substantially completely and randomly oriented, extends through the interior of the susceptor.

21. The oven as claimed in claim 1, wherein the container is formed as a closed container and divides the firing chamber into the susceptor interior and the susceptor exterior, wherein one or more dental restoration parts is to be burned, being completely accommodated within the interior of the susceptor.

22. A container for dental restoration parts, said container comprising a flat container bottom and a circumferential side wall, a container cover or hood by means of which the container may be closed, wherein the container as a closed susceptor container is intended for being introduced into a conventional dental burning oven, is fabricated of a highly thermally conductive material and comprises a wall thickness of less than about 5 mm.

23. The container as claimed in claim 22, wherein the highly thermally conductive material comprises silicon carbide and the wall thickness is approximately 2 mm.

24. A method for sintering a dental restoration part made from dental ceramics, said method using an oven comprising a firing chamber and a thermal heating component, the method comprising
introducing the dental restoration part into the firing chamber of the burning oven for sintering, wherein the dental restoration part has an extension of about 80 mm or more,
inserting the dental restoration part into a susceptor within the firing chamber, and
subjecting the dental restoration part to thermal treatment in the oven for a time of less than about 100 min.

25. The method of claim 24 where the dental ceramics comprise zirconium dioxide (ZrO₂), and the susceptor is fabricated of silicon carbide.

26. The method as claimed in claim 24, wherein the dental restoration part is inserted into the susceptor at a room temperature of less than about 50° C. or at the temperature of a preheating oven, and that the susceptor remains closed during the thermal treatment cycle.
